(19) United States
(12) Patent Application Publication
(10) Pub. No.: US 2026/0288981 A1
(43) Pub. Date: Sep. 24, 2026

(54) ENCRYPTION DEVICE, ENCRYPTION METHOD, AND RECORDING MEDIUM

(71) Applicant: NEC Corporation, Tokyo (JP)

(72) Inventors: Akihiro YAGIHASHI, Tokyo (JP); Akihiko KATO, Tokyo (JP); Tadayoshi INUMARU, Tokyo (JP)

(73) Assignee: NEC Corporation, Tokyo (JP)

(21) Appl. No.: 19/430,639

(22) Filed: Dec. 23, 2025

(30) Foreign Application Priority Data
Mar. 24, 2025 (JP) 2025-047834

(51) Int. Cl. G06F 21/60; G06F 21/62

(52) U.S. Cl. CPC G06F 21/602; G06F 21/6209

(57) ABSTRACT

An encryption device includes one or more memories storing instructions; and one or more processors configured to execute the instructions to: acquire data to be transmitted, acquire characteristic information indicating a characteristic related to transmission and reception of the acquired data, determine an encryption scheme for encrypting the data by inputting the acquired characteristic information to a trained model for determining the encryption scheme for achieving encryption strength suitable for a data importance level based on the characteristic information, encrypt the data using the determined encryption scheme, and output the encrypted data.

This application is based upon and claims the benefit of priority from Japanese Patent Application No. 2025-047834, filed on Mar. 24, 2025, the disclosure of which is incorporated herein in its entirety by reference.

### TECHNICAL FIELD

The present disclosure relates to an encryption device, an encryption method, and a recording medium.

### BACKGROUND ART

JP 2002-190798 A discloses an encryption device that performs encryption on data blocks obtained by dividing data, which is a source of data to be transmitted, for each type depending on an importance level determined in accordance with a preset analysis rule.

### SUMMARY

An exemplary object of the present disclosure is to provide a technique for performing encryption with an appropriate encryption scheme in a technique of performing encryption with an encryption scheme suitable for data to be transmitted.

An encryption device according to an aspect of the present disclosure includes a data acquisition means for obtaining data to be transmitted, a characteristic acquisition means for obtaining characteristic information indicating a characteristic related to transmission and reception of the obtained data, a determination means for determining an encryption scheme for encrypting the data by inputting the obtained characteristic information to a trained model for determining the encryption scheme for achieving encryption strength suitable for a data importance level based on the characteristic information, an encryption means for encrypting the data using the determined encryption scheme, and an output means for outputting the encrypted data.

An encryption method according to an aspect of the present disclosure includes obtaining data to be transmitted, obtaining characteristic information indicating a characteristic related to transmission and reception of the obtained data, determining an encryption scheme for encrypting the data by inputting the obtained characteristic information to a trained model for determining the encryption scheme for achieving encryption strength suitable for a data importance level based on the characteristic information, encrypting the data using the determined encryption scheme, and outputting the encrypted data.

A program according to an aspect of the present disclosure causes a computer to perform a process including obtaining data to be transmitted, obtaining characteristic information indicating a characteristic related to transmission and reception of the obtained data, determining an encryption scheme for encrypting the data by inputting the obtained characteristic information to a trained model for determining the encryption scheme for achieving encryption strength suitable for a data importance level based on the characteristic information, encrypting the data using the determined encryption scheme, and outputting the encrypted data.

The program may be stored in a non-transitory computer-readable recording medium.

An exemplary effect of the present disclosure is that encryption may be performed with an appropriate encryption scheme in a technique of performing encryption with an encryption scheme suitable for data to be transmitted.

### BRIEF DESCRIPTION OF THE DRAWINGS

FIG. 1 is an explanatory diagram for explaining a flow of data processing using an encryption device;

FIG. 2 is a block diagram illustrating an exemplary functional configuration of the encryption device;

FIG. 3 is a flowchart illustrating an exemplary operation of the encryption device;

FIG. 4 is a block diagram illustrating another exemplary functional configuration of the encryption device;

FIG. 5 is a block diagram illustrating another exemplary functional configuration of the encryption device;

FIG. 6 is a block diagram illustrating another exemplary functional configuration of the encryption device; and

FIG. 7 is a diagram illustrating a hardware configuration in which the encryption device according to the present disclosure is implemented by a computer and its peripheral devices.

### EXAMPLE EMBODIMENT

Hereinafter, an example embodiment of the present disclosure will be described in detail with reference to the drawings.

### Example Embodiment

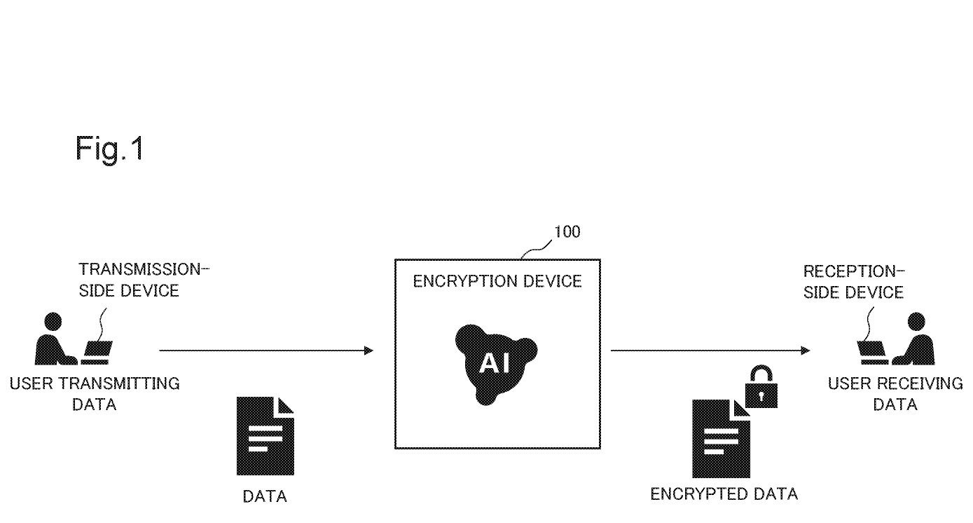

FIG. 1 is an explanatory diagram conceptually illustrating a flow of data processing related to data encrypted by an encryption device 100.

First, an exemplary configuration of an encryption system including the encryption device 100 in FIG. 1 will be described. In FIG. 1, the encryption system includes the encryption device 100, a transmission-side terminal, and a reception-side terminal.

The encryption device 100 is a device that determines an encryption scheme for encrypting data to be transmitted from the transmission-side terminal device to the reception-side terminal device and encrypts the data. The encryption device 100 determines the encryption scheme using a trained model.

The trained model may be provided in the encryption device 100, or may be communicably provided outside the encryption device 100. In the case where the trained model is communicably provided outside the encryption device 100, the encryption device 100 and the trained model are assumed to be connected by a method with a low security risk, such as wired connection, a local network, or the like. The trained model will be detailed later.

For example, the encryption device 100 may be provided in a transmission-side device that transmits data, or may be implemented by a cloud computing system or a server communicably connected to one or a plurality of transmission-side devices.

The encryption device 100 is communicably connected to the transmission-side device. The encryption device 100 may be further communicably connected to a reception-side device.

The transmission-side device is a device that transmits data. While the transmission-side device may be, for example, a terminal device such as a smartphone, a tablet, a personal computer (PC), a wearable terminal, or the like, the transmission-side device is not limited to the terminal device, and only needs to be a device that transmits data to an external device, such as a server.

The reception-side device is a device that receives data. In a similar manner to the transmission-side device, while the reception-side device may be, for example, a terminal device such as a smartphone, a tablet, a PC, a wearable terminal, or the like, the reception-side device is not limited to the terminal device, and only needs to be a device that receives data from an external device, such as a server.

Next, a flow of the data encrypted by the encryption device 100 will be described.

The encryption device 100 determines the encryption scheme for encrypting the data to be transmitted from the transmission-side device, and the data is encrypted using the determined encryption scheme. The encrypted data is transmitted to the reception-side device. The reception-side device decrypts the encrypted data by a method relevant to the encryption scheme, whereby, for example, a user who receives the data is enabled to view the data.

The encrypted data may be transmitted to the reception-side device by the encryption device 100, or may be transmitted by the transmission-side device.

Next, a functional configuration of the encryption device 100 according to an example embodiment will be described.

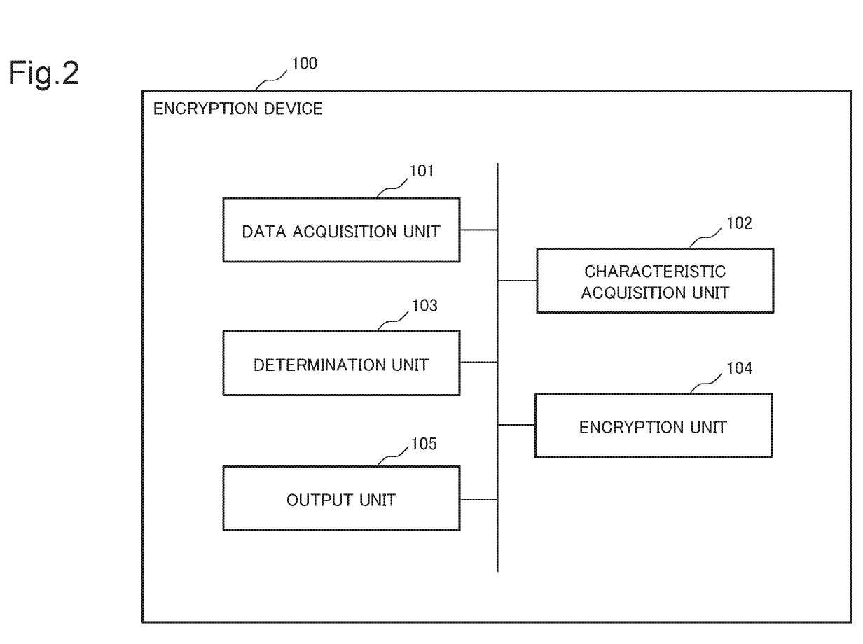

FIG. 2 is a block diagram illustrating the functional configuration of the encryption device 100. Referring to FIG. 2, the encryption device 100 includes a data acquisition unit 101, a characteristic acquisition unit 102, a determination unit 103, an encryption unit 104, and an output unit 105.

Next, the functional configuration of the encryption device 100 will be described in detail.

The data acquisition unit 101 is an exemplary data acquisition means for obtaining data to be transmitted. For example, the data acquisition unit 101 obtains the data to be transmitted by the transmission-side device from the transmission-side device. A method for obtaining the data to be transmitted is not particularly limited, and a known method may be used.

The data acquisition unit 101 may obtain only data to be encrypted among the pieces of data to be transmitted, or may obtain only data to be subject to determination regarding encryption scheme for performing encryption among the pieces of data to be transmitted. The data to be encrypted among the pieces of data to be transmitted, and the data to be subject to the determination regarding the encryption scheme for performing encryption among the pieces of data to be transmitted may be designated by the user who transmits the data using the transmission-side device, for example.

The data to be transmitted may be data such as an email, chat, or the like, data indicating a condition to be sequentially shared such as positional information, or voice or video data of a call, and is not particularly limited.

The characteristic acquisition unit 102 is an exemplary characteristic acquisition means for obtaining characteristic information indicating characteristics related to transmission and reception of the obtained data.

For example, the characteristic acquisition unit 102 may obtain the characteristic information from the transmission-side device that transmits the data, or may obtain the characteristic information from a terminal device of the user who uses the transmission-side device that transmits the data different from the transmission-side device. Information regarding the terminal device of the user who uses the transmission-side device that transmits the data may be associated in advance with, for example, the transmission-side device or an account logged in at the transmission-side device.

The characteristic information is information indicating characteristics related to transmission and reception of data. The characteristic information may include, for example, at least one of information indicating characteristics of the data itself and information indicating characteristics of a condition of the user who transmits the data.

Examples of the information indicating the characteristics of the data itself include details of the data. In that case, examples of the information indicating the characteristics of the data itself include text, voice, an image, and the like of the data to be transmitted. The information indicating the characteristics of the data itself may be characteristics specified from the text, voice, image, and the like. The characteristics specified from the text, voice, and image may be, for example, whether a predetermined keyword is included in the text or voice, or may be whether a predetermined object is included in the image. Whether the predetermined keyword is included in the voice may be determined using a known voice recognition technique. Whether the predetermined object is included in the image may be determined using a known image recognition technique. The image may be a moving image, or may be a still image.

Examples of the information indicating the characteristics of the data itself further include information regarding transmission and reception of data. In that case, for example, the information indicating the characteristics of the data itself is at least one of a transmission destination Internet Protocol (IP) address and a transmission source IP address. That is, the information indicating the characteristics of the data itself may be either the transmission destination IP address or the transmission source IP address, or may be a combination of the transmission destination IP address and the transmission source IP address. The information indicating the characteristics of the data itself may be characteristics specified from the transmission destination IP address or the transmission source IP address. For example, the characteristics specified from the IP address may be whether the IP address belongs to a specific region or organization, or may be whether the IP address is included in a predetermined IP address list.

Examples of the information indicating the characteristics of the data itself further include a flag assigned to the data. In that case, examples of the information indicating the characteristics of the data itself include presence or absence of an emergency flag. The emergency flag may indicate an emergency status, or may be a numerical value or a character string indicating a plurality of emergency levels.

Examples of the information indicating the characteristics of the data itself further include information regarding personal information included in the data. In that case, examples of the information indicating the characteristics of the data itself include personal information such as an individual number, a personal identification number, an account number, a password, information indicating a diagnosis result, an image to be used for diagnosis, and the like. Examples of the information indicating the characteristics of the data itself may further include presence or absence or a type of the personal information.

Examples of the information indicating the characteristics of the condition of the user who transmits the data include information indicating a place where the user who transmits the data stays. In that case, examples of the information indicating the characteristics of the condition of the user who transmits the data include positional information of the terminal device carried by the user. It may also be information indicating a facility or a region where the user stays, which is identified based on the positional information of the terminal device carried by the user, or information indicating whether the place where the user stays is a place where data of high importance may be exchanged, for example. Examples of the place where data of high importance may be exchanged include a hazardous region, a facility where operations or contracts involving confidential information are likely to be handled, and the like. The place where data of high importance may be exchanged is not limited to those examples, and may be set in advance.

Examples of the information indicating the characteristics of the condition of the user who transmits the data further include information regarding a system used by the user. Here, examples of the system used by the user include an application used by the user in the terminal device, a database accessed from the terminal device, and the like. In that case, examples of the information indicating the characteristics of the condition of the user who transmits the data include information indicating the system used by the user before transmitting the data, information indicating a system from which a part or all of the data to be transmitted is obtained, and the like. More specifically, the information regarding the system used by the user may be an operation log of the transmission-side device or terminal device regarding the system used by the user through the transmission-side device or terminal device. Here, the system used by the user before transmitting the data may be a system used in a predetermined period before the data transmission, or may be a system used immediately before the data transmission. The predetermined period may be, for example, a period during which use of the system intended to browse information associated with the data to be transmitted is expected, such as five minutes. Examples of the information indicating the characteristics of the condition of the user who transmits the data may further include information indicating whether the system used by the user handles data of high importance. In that case, information indicating that the system handles data of high importance may be set in advance.

Examples of the information indicating the characteristics of the condition of the user who transmits the data further include information regarding a movement situation of the user. In that case, examples of the information indicating the characteristics of the condition of the user who transmits the data further include information indicating a transportation means of the user. Examples of the information indicating the characteristics of the condition of the user who transmits the data may further include a history of the positional information for estimating the transportation means. For example, the transportation means may be estimated from a moving speed or a moving route based on the history of the positional information. Here, examples of the transportation means include an airplane, a ship, a helicopter, a walk, a train, a bicycle, a car, and the like. Examples of the information indicating the characteristics of the condition of the user who transmits the data may further include information indicating a moving speed or a moving range of the user, which is identified based on the transportation means of the user, and information indicating whether the transportation means of the user is in a movement situation in which data of high importance may be exchanged. Examples of the movement situation in which data of high importance may be exchanged include transportation in an emergency or in a hazardous situation using an airplane or a helicopter different from a general passenger airplane. The movement situation in which data of high importance may be exchanged is not limited to those examples, and may be set in advance.

The characteristic acquisition unit 102 may obtain at least one or a plurality of pieces of those pieces of characteristic information. The characteristic information only needs to be information relevant to an importance level of the data or necessity of encryption to be described later, and is not limited to those examples.

The determination unit 103 is an exemplary determination means for determining the encryption scheme for encrypting the data by inputting the obtained characteristic information to a trained model for determining the encryption scheme for achieving encryption strength suitable for the importance level of the data based on the characteristic information. The trained model to be used by the determination unit 103 to determine the encryption scheme is a trained model for determining the encryption scheme for achieving the encryption strength suitable for the importance level of the data based on the characteristic information. That is, the trained model may be a trained model trained to output the encryption scheme for achieving the encryption strength suitable for the importance level of the data based on the characteristic information, or may be a trained model trained to output information for determining the encryption scheme based on the characteristic information. The information for determining the encryption scheme is the importance level of the data estimated from the characteristic information and the encryption strength appropriate for the data estimated from the characteristic information.

Here, the importance level of the data indicates a degree of importance of the data. In other words, it is necessity of data security. Since data of high importance involves high necessity for maintaining security, encryption using the encryption scheme with higher encryption strength is required. On the other hand, since data of low importance involves low necessity for maintaining security, encryption using the encryption scheme with higher encryption strength is not required. The encryption scheme with higher encryption strength generally increases the load of processing for encryption and decryption and the load of transmission/reception and storage of data caused by a large volume of encrypted data. Thus, data of low importance may be required not to be encrypted or to be encrypted by an encryption scheme with lower encryption strength. In a case of using quantum cryptography as an encryption scheme with higher encryption strength, the number of quanta that may be used for encryption may be limited, whereby it may be required to encrypt only data of particularly high importance using the quantum cryptography.

Thus, it is required to encrypt the data using an encryption scheme that achieves appropriate encryption strength depending on the importance level of the data. In view of the above, the determination unit 103 determines the encryption scheme appropriate for the importance level of the data using the trained model for determining the encryption scheme for achieving the encryption strength suitable for the importance level of the data based on the characteristic information.

The encryption scheme determined by the determination unit 103 may include not only a type of the encryption but also values that affect the encryption strength, such as a length of an encryption key or decryption key to be used in the encryption scheme, a frequency of updating the encryption key, a block length of the data to be encrypted, and the like. The encryption scheme determined by the determination unit 103 may further include a combination of equal to or more than two encryption schemes. Furthermore, the encryption scheme determined by the determination unit 103 may include non-execution of the encryption. An encryption scheme available for the device that performs the encryption is used as the encryption scheme determined by the determination unit 103. An example of the encryption scheme will be described later.

Examples of the trained model include a trained model that has learned the characteristic information associated with the data to be transmitted and the importance level of the data. In that case, for example, the determination unit 103 determines the encryption scheme depending on the importance level of the data obtained by inputting the characteristic information to the trained model. The encryption scheme suitable for the importance level of the data may be set in advance, or may be appropriately determined depending on a situation. Determination of the encryption scheme suitable for the importance level of the data, which is appropriately made depending on the situation, will be described in a second modified example.

The importance level of the data may be represented by a plurality of preset stages. The importance level of the data, which is associated with the characteristic information and is used to train the trained model, may be annotated by a human, or may be estimated based on a history of the encryption scheme or encryption strength in which the data to be transmitted is encrypted. As a method of the estimation, it may be estimated based on information indicating the encryption scheme or encryption strength and the importance level of the relevant data, or another known method may be used.

Examples of the trained model may further include a trained model that has learned the characteristic information associated with the data to be transmitted and the encryption strength of the encryption scheme for encrypting the data. In that case, the determination unit 103 determines the encryption scheme depending on the encryption strength obtained by inputting the characteristic information to the trained model. The encryption scheme suitable for the encryption strength may be set in advance.

The encryption strength may be represented by a plurality of preset stages. The encryption strength, which is associated with the characteristic information and is used to train the trained model, may be annotated by a human, or may be estimated based on the history of the encryption scheme by which the data to be transmitted is encrypted. As a method of the estimation, it may be estimated based on information indicating the encryption scheme and the encryption strength of the relevant data, or another known method may be used.

Examples of the trained model may further include a trained model that has learned the characteristic information and the encryption scheme for encrypting the data. In that case, the determination unit 103 determines the encryption scheme by inputting the characteristic information to the trained model.

The encryption scheme, which is associated with the characteristic information and is used to train the trained model, may be the history of the encryption scheme by which the data to be transmitted is encrypted. The encryption scheme, which is associated with the characteristic information and is used to train the trained model, may be annotated by a human.

Next, examples of the encryption scheme suitable for the characteristic information determined by the determination unit 103 and the importance level and encryption strength of the data related to the encryption scheme will be described.

Examples of the characteristic information include details of the data. As described above, the details of the data are text, voice, or an image. For example, since the importance level of the data is considered to be higher in a case where a keyword determined to be important is included in the text or voice or in a case where an object determined to be important is included in the image, the determination unit 103 determines the encryption scheme of the data to be the encryption scheme with higher encryption strength.

Examples of the characteristic information may further include the information regarding the transmission and reception of the data. As described above, the information regarding the transmission and reception of the data is the transmission destination IP address or the transmission source IP address. For example, since the importance level of the data is considered to be higher in a case where the transmission destination IP address or the transmission source IP address is an IP address belonging to a specific organization or region or is included in a predetermined IP address list determined to be important, the determination unit 103 determines the encryption scheme of the data to be the encryption scheme with higher encryption strength. Since the importance level of the data is considered to be higher in a case where the combination of the transmission destination IP address and the transmission source IP address corresponds to a combination of high importance, the determination unit 103 determines the encryption scheme of the data to be the encryption scheme with higher encryption strength.

Examples of the characteristic information further include the flag assigned to the data. As described above, the flag assigned to the data is the emergency flag. For example, if the emergency flag is set for the data, the importance level of the data is considered to be higher, and thus the determination unit 103 determines the encryption scheme of the data to be the encryption scheme with higher encryption strength.

Examples of the characteristic information further include the information regarding the personal information included in the data. As described above, the information regarding the personal information included in the data includes personal information such as an individual number, a personal identification number, an account number, a password, information indicating a diagnosis result, or an image to be used for diagnosis, and presence or absence or a type of the personal information. Since the importance level of the data is considered to be higher in a case where important personal information or a plurality of pieces of personal information is included in the data, the determination unit 103 determines the encryption scheme of the data to be the encryption scheme with higher encryption strength.

Examples of the characteristic information further include information indicating the place where the user who transmits the data stays. As described above, the information indicating the place where the user stays includes the positional information of the terminal device carried by the user. For example, if the terminal device of the user is located in a specific area or facility, the importance level of the data to be transmitted from the location is considered to be higher, and thus the determination unit 103 determines the encryption scheme of the data to be the encryption scheme with higher encryption strength. Since the importance level of the data is estimated to be higher in a case where the positional information of the user indicates a place different from a normal behavioral pattern or in a case where the position is frequently changed, the determination unit 103 may determine the encryption scheme of the data to be the encryption scheme with higher encryption strength.

Examples of the characteristic information further include the information regarding the system used by the user. As described above, the information regarding the system used by the user includes the information indicating the system used by the user before transmitting the data, the information indicating a system from which a part or all of the data to be transmitted is obtained, and the like. For example, if the user transmits the data after using a system that handles information of high importance, it is considered that the data is highly likely to include information of high importance, and thus the determination unit 103 determines the encryption scheme of the data to be the encryption scheme with higher encryption strength.

Examples of the characteristic information further include the information regarding the movement situation of the user. As described above, the information regarding the movement situation of the user includes the information indicating the transportation means of the user. Since the importance level of the data is considered to be higher in a case where the data is transmitted while the user is using a special transportation means, the determination unit 103 determines the encryption scheme of the data to be the encryption scheme with higher encryption strength.

The importance level, encryption strength, and encryption scheme of the data according to the characteristic information are not limited to those examples. Since the importance level, encryption strength, and encryption scheme of the data are considered to be different depending on the combination of the characteristic information, the determination unit 103 may determine the encryption scheme suitable for the combination of the characteristic information using a plurality of pieces of the characteristic information.

Next, examples of the encryption scheme and its encryption strength will be described. While an exemplary case where quantum cryptography, an Advanced Encryption Standard (AES), and a Rivest-Shamir-Adleman (RSA) cryptosystem are adopted as the encryption scheme will be described in the following descriptions, the encryption scheme is not limited to those examples, and a known encryption scheme may be used.

For example, the encryption strength may be set to four levels. In that case, for example, the quantum cryptography may be used at a high level, which is a level at which the encryption strength is the highest. Here, the quantum cryptography includes a one-time pad for encrypting and decrypting the data and quantum key distribution.

The one-time pad is a scheme in which each bit of the data is used for encryption and decryption using, as an encryption key, a random number having the same length as the data to be exchanged shared in advance between a sender and a recipient, and the encryption key is discarded each time the encryption key is used once.

The quantum key distribution is a mechanism in which the encryption key described above is given to a photon or a phase difference between weak light waves and ordinary light, and is shared in advance using the photon. The quantum key distribution is performed using a quantum key distribution device on each of a data transmission side that encrypts the data and a data reception side that decrypts the data. In the quantum key distribution, a photon changes in a case of being intercepted by an attacker when the photon is transmitted from a transmitter of the quantum key distribution device to a receiver of the quantum key distribution device. With the changed photon not used as the encryption key, the quantum key distribution increases the encryption strength. While examples of the quantum key distribution scheme include a BB84 system proposed by Charles Henry Bennett and Gilles Brassard in 1984 and a continuous-variable quantum key distribution (CV-QKD) system, the quantum key distribution scheme is not particularly limited.

For example, a common key cryptosystem is used at a medium level, which is a level at which the encryption strength is the second highest, among the encryption strength set in the four levels. For example, at the medium level, a combination of the AES, which is a scheme of encryption and decryption, and the quantum key distribution, which is a scheme for sharing an encryption key, may be used. In that case, for example, a common key of the AES may be shared in advance between the sender and the recipient of the data by the quantum key distribution, and the data may be encrypted and decrypted using the shared common key.

For example, a public-key cryptosystem is used at a low level, which is a level at which the encryption strength is the third highest, among the encryption strength set in the four levels. For example, the RSA may be used at the low level. In that case, for example, the recipient of the data generates a public key for encryption and a private key for decryption, and shares the public key with the sender of the data. The sender of the data encrypts the data using the public key, and transmits the encrypted data to the recipient of the data. The recipient of the data decrypts, using the private key, the data encrypted using the public key.

For example, no encryption is carried out at a zero level, which is a level at which the encryption strength is the lowest, among the encryption strength set in the four levels.

The levels of the encryption strength are not limited to this example, and the levels of the encryption strength may be further reduced, or may be further increased. The levels of the encryption strength may not include the level at which no encryption is performed.

For example, in a case of increasing the levels of the encryption strength, various methods may be applied to set the encryption scheme with different encryption strength, such as changing a block length of the data to be encrypted, changing an update frequency of the common key, changing a key length of the encryption key, adopting another encryption scheme, changing the combination of encryption schemes, and the like.

The determination unit 103 may determine the encryption scheme for encrypting the data as an available encryption scheme based on information indicating an available encryption scheme for each transmission destination or each combination of a transmission source and transmission destination of the data.

The encryption unit 104 is an exemplary encryption means for encrypting the data with the determined encryption scheme. The encryption unit 104 may encrypt the data using a method relevant to the determined encryption scheme.

The output unit 105 is an exemplary output means for outputting the encrypted data.

An output destination to which the output unit 105 outputs the encrypted data may be the reception-side device, or may be the transmission-side device. In a case where the output unit 105 outputs the encrypted data to the transmission-side device, the transmission-side device transmits the encrypted data to the reception-side device.

Here, the output unit 105 may output, in addition to the encrypted data, information for decrypting the encrypted data. Examples of the information for decrypting the encrypted data include information indicating the encryption scheme.

In a case where the encryption key needs to be newly distributed, the output unit 105 may output an instruction of encryption key distribution to a device that distributes the encryption key.

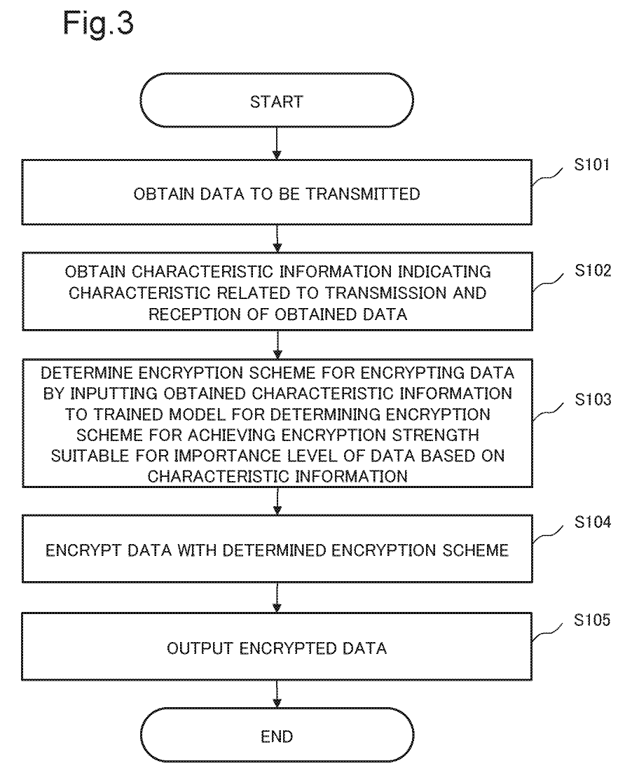

An operation of the encryption device 100 configured as described above will be described with reference to a flowchart of FIG. 3.

First, the data acquisition unit 101 obtains the data to be transmitted (step S101).

Next, the characteristic acquisition unit 102 obtains the characteristic information indicating the characteristics related to transmission and reception of the data obtained in step S101 (step S102). The processing of step S102 may be performed simultaneously with step S101.

Next, the determination unit 103 inputs the characteristic information obtained in step S102 to the trained model for determining the encryption scheme for achieving the encryption strength suitable for the importance level of the data based on the characteristic information, thereby determining the encryption scheme for encrypting the data (step S103).

Next, the encryption unit 104 encrypts the data with the encryption scheme determined in step S103 (step S104).

Then, the output unit 105 outputs the data encrypted in step S104 (step S105).

As described above, the encryption device 100 ends the series of operations. The series of operations of the encryption device 100 may be statically performed at timing of transmitting data, such as an email, chat, or the like, or at timing of starting a voice call or video call, or may be dynamically performed during data transmission and reception, such as during a voice call or video call.

The encryption device 100 described above includes the data acquisition unit 101, the characteristic acquisition unit 102, the determination unit 103, the encryption unit 104, and the output unit 105. The data acquisition unit 101 obtains the data to be transmitted. The characteristic acquisition unit 102 obtains the characteristic information indicating the characteristics related to transmission and reception of the obtained data. The determination unit 103 determines the encryption scheme for encrypting the data by inputting the obtained characteristic information to the trained model for determining the encryption scheme for achieving the encryption strength suitable for the importance level of the data based on the characteristic information. The encryption unit 104 encrypts the data with the encryption scheme determined in step S103. Then, the output unit 105 outputs the data encrypted in step S104.

According to the encryption device 100, it becomes possible to encrypt the data with the encryption scheme for achieving the encryption strength suitable for the importance level of the data estimated based on the characteristic information regarding the data. As a result, the encryption device 100 is enabled to perform encryption with an appropriate encryption scheme in a technique of performing encryption with an encryption scheme suitable for data to be transmitted.

### Modified Example

Next, first to fifth modified examples according to the present disclosure will be described. Hereinafter, descriptions of content overlapping with the descriptions above will be omitted to the extent that descriptions of the modified examples are not unclear. The first to fifth modified examples and the example embodiment may be combined as appropriate.

### First Modified Example

The first modified example is an example in which determination of an encryption scheme using a preset rule, that is, information set in advance according to characteristic information, and determination of an encryption scheme using a trained model are changed to be combined.

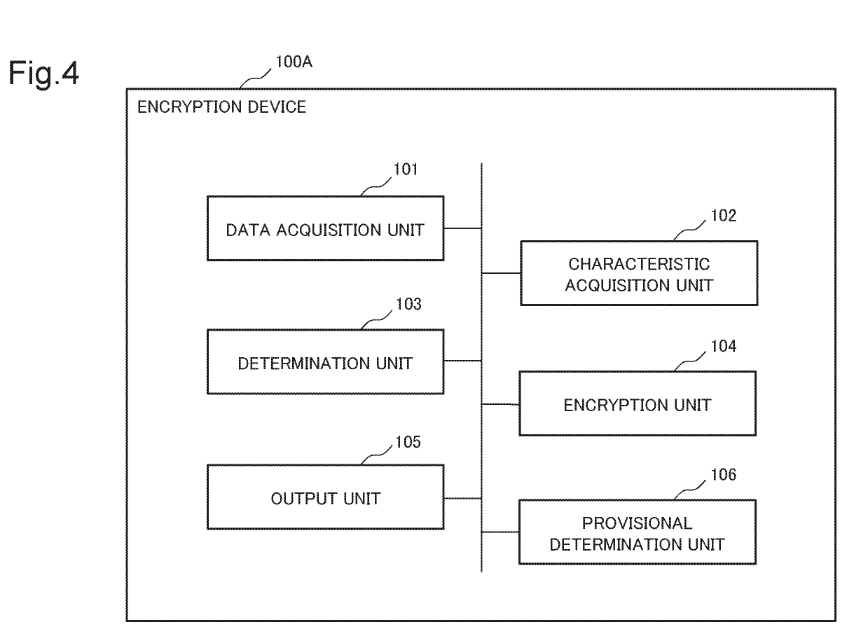

FIG. 4 is a block diagram illustrating a functional configuration of an encryption device. In FIG. 4, an encryption device 100A includes a provisional determination unit 106 in addition to the configuration of the encryption device 100.

The provisional determination unit 106 is an exemplary provisional determination means for provisionally determining a provisional encryption scheme, provisional encryption strength, or a provisional data importance level based on the characteristic information and the information set in advance according to the characteristic information. In the encryption device 100A, a determination unit 103 determines an encryption scheme for encrypting data by inputting the characteristic information to the trained model if the provisionally determined content satisfies a predetermined condition. The provisionally determined content includes the provisional encryption scheme, the provisional encryption strength, or the provisional data importance level.

Examples of the predetermined condition include that encryption strength of the provisional encryption scheme, the provisional encryption strength, or the provisional data importance level is low. The condition that the encryption strength of the provisional encryption scheme, the provisional encryption strength, or the provisional data importance level is low may indicate that the encryption strength of the provisional encryption scheme, the provisional encryption strength, or the provisional data importance level is lower than a predetermined level or predetermined value. The condition that the encryption strength of the provisional encryption scheme, the provisional encryption strength, or the provisional data importance level is low may indicate that the encryption strength of the provisional encryption scheme, the provisional encryption strength, or the provisional data importance level is relatively low among pieces of data to be processed for transmission during a predetermined period of time.

In the case where the predetermined condition is that the encryption strength of the provisional encryption scheme, the provisional encryption strength, or the provisional data importance level is low, the determination unit 103 determines the encryption scheme for encrypting the data satisfying the predetermined condition, whereby the determination processing of the determination unit 103 using the trained model may be reduced. As a result, a processing load of the encryption device 100A may be reduced, and a processing speed of the encryption device 100A may be improved. This may avoid encryption of data of high importance with low encryption strength.

Examples of the predetermined condition include that the encryption strength of the provisional encryption scheme, the provisional encryption strength, or the provisional data importance level is high. The condition that the encryption strength of the provisional encryption scheme, the provisional encryption strength, or the provisional data importance level is high may indicate that the encryption strength of the provisional encryption scheme, the provisional encryption strength, or the provisional data importance level is higher than a predetermined level or predetermined value. The condition that the encryption strength of the provisional encryption scheme, the provisional encryption strength, or the provisional data importance level is high may indicate that the encryption strength of the provisional encryption scheme, the provisional encryption strength, or the provisional data importance level is relatively high among the pieces of data to be processed for transmission during the predetermined period of time.

In the case where the predetermined condition is that the encryption strength of the provisional encryption scheme, the provisional encryption strength, or the provisional data importance level is high, the determination unit 103 determines the encryption scheme for encrypting the data satisfying the predetermined condition, whereby the determination processing of the determination unit 103 using the trained model may be reduced. As a result, a processing load of the encryption device 100A may be reduced, and a processing speed of the encryption device 100A may be improved. This may avoid an increase in the processing load caused by encryption of data of low importance with high encryption strength. This may enable selection of more appropriate encryption scheme for data of high importance.

The characteristic information used by the provisional determination unit 106 to provisionally determine provisional content and the characteristic information used by the determination unit 103 to determine the encryption scheme may be the same, or may be different. For example, the characteristic information used by the provisional determination unit 106 to provisionally determine the provisional content may be the characteristic information indicating characteristics of the data itself, and the characteristic information used by the determination unit 103 to determine the encryption scheme may be the characteristic information indicating characteristics of a condition of a user who transmits the data, or may be a combination of the characteristic information indicating the characteristics of the data itself and the characteristic information indicating the characteristics of the condition of the user who transmits the data.

The number of levels of the provisional data importance level or provisional encryption strength provisionally determined by the provisional determination unit 106 may be different from the number of levels of the data importance level or encryption strength caused to be estimated by the determination unit 103 using the trained model. For example, the number of levels of the provisional data importance level or provisional encryption strength provisionally determined by the provisional determination unit 106 may be set to be smaller than the number of levels of the data importance level or encryption strength caused to be estimated by the determination unit 103 using the trained model. In that case, the predetermined condition is that the level of the provisional data importance level or provisional encryption strength is a predetermined level, and the determination unit 103 determines the encryption scheme for encrypting the data satisfying the predetermined condition. Here, examples of the predetermined level include a medium level at which the encryption scheme is difficult to determine, and a high level and a low level at which the encryption scheme needs to be appropriately determined.

### Second Modified Example

The second modified example is an example in which the encryption scheme for encrypting the data is relatively determined depending on a state of processing related to data to be transmitted in addition to the characteristic information.

For example, the determination unit 103 may relatively determine the encryption scheme in such a way that more resources related to the processing are used for the data to be processed for transmission during a predetermined period of time. The predetermined period of time may be appropriately set depending on a time required for the processing for transmission. The processing for transmission includes encryption processing and transmission processing. Examples of the resource related to the processing for transmission include a memory or processor for performing an encryption operation, a communication band, the number of quanta to be used for quantum cryptography, and the like.

For example, if there is no or a small number of encryption schemes with higher encryption strength among pieces of data to be processed for transmission during the predetermined period of time, the encryption scheme for encrypting the data in which the encryption strength of the encryption scheme determined by the determination unit 103 or the encryption strength or data importance level estimated by the trained model is high may be determined as the encryption scheme with higher encryption strength. Here, the data in which the encryption strength of the encryption scheme determined by the determination unit 103 or the encryption strength or data importance level estimated by the trained model is high may be data in which the encryption strength of the encryption scheme determined by the determination unit 103 or the encryption strength or data importance level estimated by the trained model is higher than a predetermined level or predetermined value. The data in which the encryption strength of the encryption scheme determined by the determination unit 103 or the encryption strength or data importance level estimated by the trained model is high may be data in which the encryption strength of the encryption scheme determined by the determination unit 103 or the encryption strength or data importance level estimated by the trained model is included in a predetermined number from the top or in a predetermined ratio from the top among the plurality of pieces of data.

In that case, for example, the determination unit 103 may determine the encryption scheme using an optimization problem. Examples of the optimization problem in this case include a problem of determining the encryption scheme of the data to minimize a remaining amount of resources using the resources used by each encryption scheme by setting a constraint condition to the encryption scheme having the encryption strength equal to or higher than that of the encryption scheme determined using the trained model.

According to the second modified example, resources may be effectively used in a technique of performing encryption with an encryption scheme suitable for data to be transmitted.

### Third Modified Example

The third modified example is an example in which, in a case of encrypting and outputting a plurality of pieces of data, encryption and output processing is performed depending on a priority level of each piece of data.

For example, an encryption unit 104 preferentially encrypts data with a higher emergency level among pieces of data to be processed for transmission during a predetermined period of time. Examples of the data with a higher emergency level include data to which an emergency flag indicating whether it is urgent is assigned. If a plurality of emergency levels is set for the data, the encryption unit 104 may encrypt the data with a higher emergency level with higher priority among the pieces of data to be processed for transmission during the predetermined period of time. In that case, an output unit 105 may preferentially output the data with a higher emergency level.

For example, if the emergency levels of the pieces of data to be processed for transmission during the predetermined period of time are the same, the encryption unit 104 may preferentially encrypt the data with higher encryption strength of the determined encryption scheme. In that case, the output unit 105 may preferentially output the data with higher encryption strength of the determined encryption scheme. This is because the encryption and output of the data with higher encryption strength are assumed to take time.

According to the third modified example, in data encryption processing and processing of outputting encrypted data, an influence of a processing time caused by encryption using a time-consuming encryption scheme with higher encryption strength may be alleviated.

### Fourth Modified Example

A fourth modified example is an example in which information regarding encryption of data is changed to be provided to the user who transmits the data.

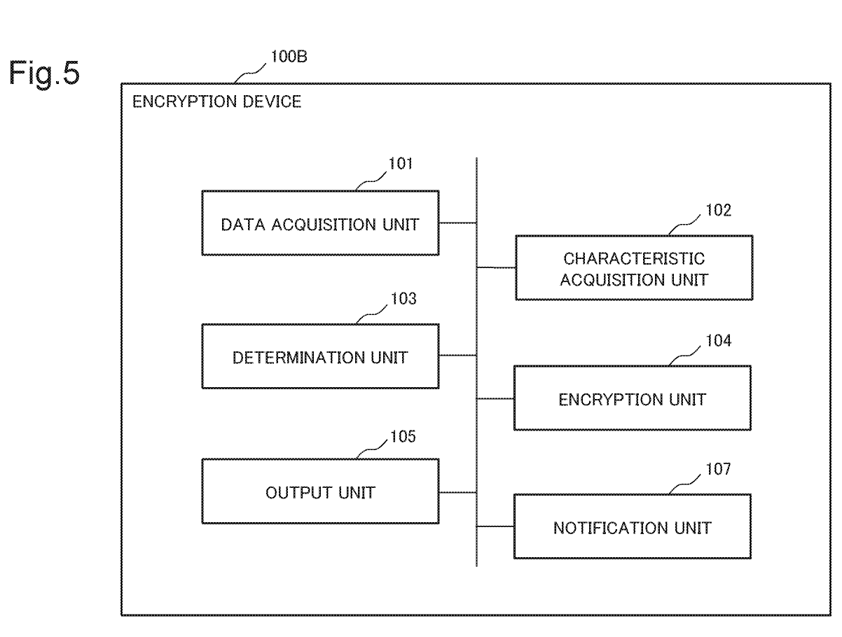

FIG. 5 is a block diagram illustrating a configuration of an encryption device. In FIG. 5, an encryption device 100B includes a notification unit 107 in addition to the configuration of the encryption device 100.

The notification unit 107 is an exemplary notification means for notifying the user who transmits the data of the information regarding the encryption of the data.

For example, the information regarding the encryption of the data is at least one of the importance level, encryption strength, and encryption scheme of the data.

For example, the notification unit 107 may make notification regarding the encryption scheme determined by the determination unit 103. The notification unit 107 may make notification regarding the encryption strength of the determined encryption scheme and the data importance level specified from the encryption scheme or encryption strength of the encryption scheme. The encryption strength of the encryption scheme and the data importance level specified from the encryption scheme or encryption strength of the encryption scheme may be stored in advance in a storage unit (not illustrated) in association with the encryption scheme.

The notification unit 107 may make notification regarding the encryption strength or data importance level output from the trained model, which is used by the determination unit 103 to determine the encryption scheme.

Examples of the information regarding the encryption of the data may further include information regarding the determined encryption scheme.

Examples of the information regarding the determined encryption scheme may further include information indicating a processing time required for processing of encrypting the data using the determined encryption scheme and processing of transmitting the encrypted data. For example, the processing time may be stored in advance in a storage unit (not illustrated) in association with the encryption scheme. For example, the processing time may be calculated based on the encryption scheme and the size of the data to be transmitted.

Examples of the information regarding the determined encryption scheme may further include information making notification regarding the fact that the determined encryption scheme cannot be used. Examples of the case where the determined encryption scheme cannot be used include a case where a failure has occurred in a quantum key distribution device, and a case where an encryption scheme using the quantum key distribution device is determined as the encryption scheme of the data to be transmitted to a data transmission destination that does not have the quantum key distribution device.

According to the fourth modified example, the user who transmits the data is enabled to know information regarding the encryption of the data, which may be utilized to ensure more reliable security of the data and the like, and to make determination regarding the data transmission while the status of the data transmission accompanied by the encryption is grasped.

### Fifth Modified Example

The fifth modified example is an example in which processing related to encryption is changed in response to a request from the user.

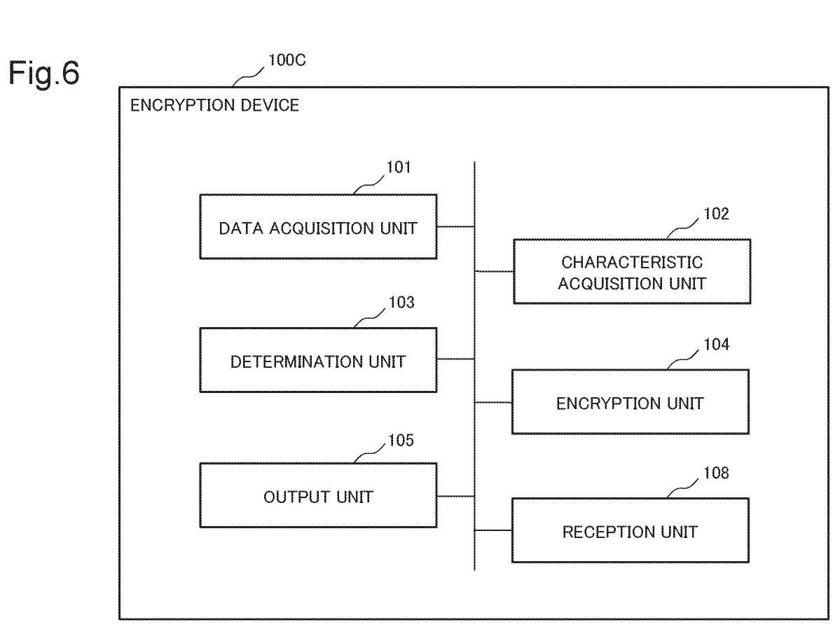

FIG. 6 is a block diagram illustrating a configuration of an encryption device. In FIG. 6, an encryption device 100C includes a reception unit 108 in addition to the configuration of the encryption device 100.

The reception unit 108 is an exemplary reception means for receiving, from the user, the request regarding processing of the encryption device 100C.

Examples of the request from the user include whether to determine the encryption scheme suitable for the characteristic information. In that case, for example, the reception unit 108 may receive selection of whether to determine the encryption scheme suitable for the characteristic information. In a case where the selection to determine the encryption scheme suitable for the characteristic information is received, the encryption device 100C may operate as described in the example embodiment. In a case where the selection not to determine the encryption scheme suitable for the characteristic information is received, the encryption device 100C may perform encryption and output processing using an encryption scheme designated by the user or preset encryption scheme. The selection of whether to determine the encryption scheme suitable for the characteristic information may be selection for the data to be transmitted during the predetermined period of time, or may be selection for each piece of the data to be transmitted.

Examples of the request from the user further include whether to make notification regarding the encryption scheme determined according to the characteristic information. In that case, for example, the reception unit 108 may receive selection of whether to make notification regarding the encryption scheme determined according to the characteristic information. In a case where the selection to make notification regarding the encryption scheme determined according to the characteristic information is received, the encryption device 100C may operate as described in the fourth modified example. In a case where the selection not to make notification regarding the encryption scheme determined according to the characteristic information is received, the encryption device 100C may operate as described in the example embodiment without making the notification. The selection of whether to make notification regarding the encryption scheme determined according to the characteristic information may be selection for the data to be transmitted during the predetermined period of time, or may be selection for each piece of the data to be transmitted.

Examples of the request from the user further include a change request for changing the encryption scheme, encryption strength, or data importance level notified as in the fourth modified example. In that case, the reception unit 108 may receive the change request in response to the notification of the notification unit 107 according to the fourth modified example. The change request may include designation of a changed encryption scheme, encryption strength, or data importance level, or may include a request to determine the encryption scheme again. For example, the encryption unit 104 may perform the encryption using the encryption scheme designated by the change request. For example, the determination unit 103 may determine the encryption scheme depending on the encryption strength or data importance level designated by the change request. For example, the determination unit 103 may determine the encryption scheme again based on the characteristic information if a request for determining the encryption scheme again is included in the change request.

According to the fifth modified example, the user who transmits the data is enabled to appropriately change the processing related to the encryption of the data to be transmitted, whereby more reliable security of the data may be ensured.

In data communication, there is a technique of ensuring data security by encrypting data to be transmitted. However, due to a large volume of encrypted data, network resources and a processing load increase.

In view of the above, there is a technique of encrypting data using an encryption scheme having strength suitable for confidentiality and importance of each piece of data.

However, in a case of determining the encryption scheme in accordance with the preset rule as in the encryption device disclosed in JP 2002-190798 A, an appropriate encryption scheme may not be determined for data not defined to be important in the rule.

### Hardware Configuration

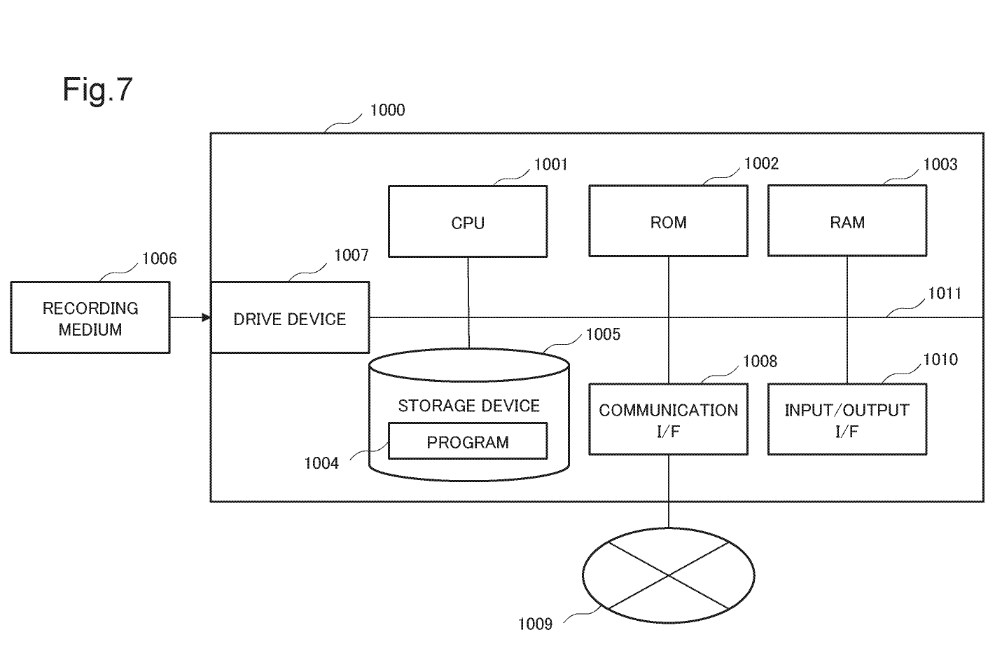

Some or all of the components of each device or system in each example embodiment and modified example of the present disclosure described above are implemented by, for example, any combination of an information processing apparatus 1000 and a program as illustrated in FIG. 7. As an example, the information processing apparatus 1000 includes the following components.

Central processing unit (CPU) 1001

Read only memory (ROM) 1002

Random access memory (RAM) 1003

Program 1004 loaded into the RAM 1003

Storage device 1005 storing the program 1004

Drive device 1007 for reading/writing a recording medium 1006

Communication I/F 1008 connected to a communication network 1009

Input/output I/F 1010 for inputting/outputting data

Bus 1011 connecting components

I/F is an abbreviation of an interface.

The components of each device or system in each example embodiment and modified example are implemented by the CPU 1001 obtaining and executing programs for implementing those functions. For example, the programs for implementing the functions of the components of each device are stored in the storage device 1005 or in the RAM 1003 in advance, and are read by the CPU 1001 as necessary. The program 1004 may be supplied to the CPU 1001 via a communication network, or may be stored in advance in the recording medium 1006 and the drive device 1007 may read the program and supply it to the CPU 1001.

There are various modified examples of the method for achieving each device. For example, each device or system may be achieved by any combination of the information processing apparatus 1000 and the program separate for each component. A plurality of components included in each device may be implemented by any combination of one information processing apparatus 1000 and the program.

Some or all of the components of each device or system are implemented by general-purpose or dedicated circuitry including a processor or the like, or a combination thereof. Examples of the circuitry include a CPU, a graphics processing unit (GPU), a field programmable gate array (FPGA), and a large scale integration (LSI) for artificial intelligence (AI) processing. These may be configured by a single chip, or may be configured by a plurality of chips connected via a bus. Some or all of the components of each device may be implemented by a combination of the above-described circuitry and the like and the program.

In a case where some or all of the components of each device or system are implemented by a plurality of the information processing apparatuses, circuitry, and the like, the plurality of information processing apparatuses, circuitry, and the like may be arranged in a centralized manner or in a distributed manner. For example, each of the information processing apparatuses, circuitry, and the like may be achieved in the form of a client server system, a cloud computing system, or the like in which they are connected to each other through the communication network.

While the present disclosure has been particularly shown and described with reference to example embodiments and modified examples thereof, the present disclosure is not limited to these example embodiments and modified examples. It will be understood by those of ordinary skill in the art that various changes in form and details may be made therein without departing from the spirit and scope of the present disclosure as defined by the claims.

Although the plurality of operations is described in order in the form of a flowchart, the order of description does not limit the order of executing the plurality of operations. Thus, in a case where each example embodiment and modified example is implemented, the order of the plurality of operations may be changed within a range that does not interfere with the content.

Some or all of the above-described example embodiments and modified examples may be described as, but are not limited to, the following Supplementary Notes.

### Supplementary Note 1

An encryption device including:

a data acquisition means for obtaining data to be transmitted;

a characteristic acquisition means for obtaining characteristic information indicating a characteristic related to transmission and reception of the obtained data;

a determination means for determining an encryption scheme for encrypting the data by inputting the obtained characteristic information to a trained model for determining the encryption scheme for achieving encryption strength suitable for a data importance level based on the characteristic information;

an encryption means for encrypting the data using the determined encryption scheme; and

an output means for outputting the encrypted data.

### Supplementary Note 2

The encryption device according to Supplementary Note 1, in which

the trained model includes a trained model that has learned the characteristic information and the data importance level, and

the determination means determines the encryption scheme according to the data importance level obtained by inputting the characteristic information to the trained model.

### Supplementary Note 3

The encryption device according to Supplementary Note 1 or 2, in which

the trained model includes a trained model that has learned the characteristic information and the encryption strength of the encryption scheme for encrypting the data, and

the determination means determines the encryption scheme according to the encryption strength obtained by inputting the characteristic information to the trained model.

### Supplementary Note 4

The encryption device according to any one of Supplementary Notes 1 to 3, in which

the trained model includes a trained model that has learned the characteristic information and the encryption scheme for encrypting the data, and

the determination means determines the encryption scheme by inputting the characteristic information to the trained model.

### Supplementary Note 5

The encryption device according to any one of Supplementary Notes 1 to 4, further including:

a provisional determination means for provisionally determining a provisional encryption scheme, provisional encryption strength, or a provisional importance level of the data based on the characteristic information and information set in advance according to the characteristic information,

in which the determination means determines the encryption scheme for encrypting the data by inputting the characteristic information to the trained model in a case where the provisionally determined provisional encryption scheme, provisional encryption strength, or provisional importance level satisfies a predetermined condition.

### Supplementary Note 6

The encryption device according to any one of Supplementary Notes 1 to 5,

in which the determination means relatively determines the encryption scheme in such a way that more resources related to processing for transmission during a predetermined period of time are used for the data to be subject to the processing.

### Supplementary Note 7

The encryption device according to any one of Supplementary Notes 1 to 6,

in which the encryption means preferentially encrypts, among pieces of the data to be subject to processing for transmission during a predetermined period of time, a piece of the data with a higher emergency level.

### Supplementary Note 8

The encryption device according to any one of Supplementary Notes 1 to 7,

in which the encryption means preferentially encrypts, in a case where an emergency level of pieces of the data to be subject to processing for transmission during a predetermined period of time is the same, a piece of the data with higher encryption strength of the determined encryption scheme.

### Supplementary Note 9

An encryption method including:

obtaining data to be transmitted;

obtaining characteristic information indicating a characteristic related to transmission and reception of the obtained data;

determining an encryption scheme for encrypting the data by inputting the obtained characteristic information to a trained model for determining the encryption scheme for achieving encryption strength suitable for a data importance level based on the characteristic information;

encrypting the data using the determined encryption scheme; and

outputting the encrypted data.

### Supplementary Note 10

A program for causing a computer to perform a process including:

obtaining data to be transmitted;

obtaining characteristic information indicating a characteristic related to transmission and reception of the obtained data;

determining an encryption scheme for encrypting the data by inputting the obtained characteristic information to a trained model for determining the encryption scheme for achieving encryption strength suitable for a data importance level based on the characteristic information;

encrypting the data using the determined encryption scheme; and

outputting the encrypted data.

Some or all of the configurations described in Supplementary Notes 2 to 8 dependent on Supplementary Note 1 described above (encryption device) may also be dependent on Supplementary Note 9 (encryption method) and Supplementary Note 10 (program) by a dependency relationship similar to that of Supplementary Notes 2 to 8. Some or all of the configurations described as Supplementary Notes may be similarly dependent on not only Supplementary Notes 1, 9, and 10, but also various pieces of hardware and software, and various recording means or systems for recording software without departing from the example embodiment and modified examples described above.

1. An encryption device comprising:
one or more memories storing instructions; and
one or more processors configured to execute the instructions to:
acquire data to be transmitted;
acquire characteristic information indicating a characteristic related to transmission and reception of the acquired data;
determine an encryption scheme for encrypting the data by inputting the acquired characteristic information to a trained model for determining the encryption scheme for achieving encryption strength suitable for a data importance level based on the characteristic information;
encrypt the data using the determined encryption scheme; and
output the encrypted data.

2. The encryption device according to claim 1, wherein
the trained model includes a trained model that has learned the characteristic information and the data importance level, and
the one or more processors are configured to execute the instructions to:
determine the encryption scheme according to the data importance level acquired by inputting the characteristic information to the trained model.

3. The encryption device according to claim 1, wherein
the trained model includes a trained model that has learned the characteristic information and the encryption strength of the encryption scheme for encrypting the data, and
the one or more processors are configured to execute the instructions to:
determine the encryption scheme according to the encryption strength acquired by inputting the characteristic information to the trained model.

4. The encryption device according to claim 1, wherein
the trained model includes a trained model that has learned the characteristic information and the encryption scheme for encrypting the data, and
the one or more processors are configured to execute the instructions to:
determine the encryption scheme by inputting the characteristic information to the trained model.

5. The encryption device according to claim 1, wherein the one or more processors are configured to execute the instructions to:
further provisionally determine a provisional encryption scheme, provisional encryption strength, or a provisional importance level of the data based on the characteristic information and information set in advance according to the characteristic information; and
determine the encryption scheme for encrypting the data by inputting the characteristic information to the trained model in a case where the provisionally determined provisional encryption scheme, provisional encryption strength, or provisional importance level satisfies a predetermined condition.

6. The encryption device according to claim 1, wherein the one or more processors are configured to execute the instructions to:
relatively determine the encryption scheme in such a way that more resources related to processing for transmission during a predetermined period of time are used for the data to be subject to the processing.

7. The encryption device according to claim 1, wherein the one or more processors are configured to execute the instructions to:
preferentially encrypt, among pieces of the data to be subject to processing for transmission during a predetermined period of time, a piece of the data with a higher emergency level.

8. The encryption device according to claim 1, wherein the one or more processors are configured to execute the instructions to:
preferentially encrypt, in a case where an emergency level of pieces of the data to be subject to processing for transmission during a predetermined period of time is the same, a piece of the data with higher encryption strength of the determined encryption scheme.

9. An encryption method, by a computer, comprising:
acquiring data to be transmitted;
acquiring characteristic information indicating a characteristic related to transmission and reception of the acquired data;
determining an encryption scheme for encrypting the data by inputting the acquired characteristic information to a trained model for determining the encryption scheme for achieving encryption strength suitable for a data importance level based on the characteristic information;
encrypting the data using the determined encryption scheme; and
outputting the encrypted data.

10. The encryption method according to claim 9, wherein
the trained model includes a trained model that has learned the characteristic information and the data importance level, and
the encryption method comprises:
determining the encryption scheme according to the data importance level acquired by inputting the characteristic information to the trained model.

11. The encryption method according to claim 9, wherein
the trained model includes a trained model that has learned the characteristic information and the encryption strength of the encryption scheme for encrypting the data, and
the encryption method comprises:
determining the encryption scheme according to the encryption strength acquired by inputting the characteristic information to the trained model.

12. The encryption method according to claim 9, wherein
the trained model includes a trained model that has learned the characteristic information and the encryption scheme for encrypting the data, and
the encryption method comprises:
determining the encryption scheme by inputting the characteristic information to the trained model.

13. The encryption method according to claim 9, wherein the encryption method comprises:
further provisionally determining a provisional encryption scheme, provisional encryption strength, or a provisional importance level of the data based on the characteristic information and information set in advance according to the characteristic information; and
determining the encryption scheme for encrypting the data by inputting the characteristic information to the trained model in a case where the provisionally determined provisional encryption scheme, provisional encryption strength, or provisional importance level satisfies a predetermined condition.

14. The encryption method according to claim 9, wherein the encryption method comprises:
relatively determining the encryption scheme in such a way that more resources related to processing for transmission during a predetermined period of time are used for the data to be subject to the processing.

15. The encryption method according to claim 9, wherein the encryption method comprises:
preferentially encrypting, among pieces of the data to be subject to processing for transmission during a predetermined period of time, a piece of the data with a higher emergency level.

16. The encryption method according to claim 9, wherein the encryption method comprises:
preferentially encrypting, in a case where an emergency level of pieces of the data to be subject to processing for transmission during a predetermined period of time is the same, a piece of the data with higher encryption strength of the determined encryption scheme.

17. A non-transitory recording medium recording a program for causing a computer to perform a process comprising:
acquiring data to be transmitted;
acquiring characteristic information indicating a characteristic related to transmission and reception of the acquired data;
determining an encryption scheme for encrypting the data by inputting the acquired characteristic information to a trained model for determining the encryption scheme for achieving encryption strength suitable for a data importance level based on the characteristic information;
encrypting the data using the determined encryption scheme; and
outputting the encrypted data.

18. The non-transitory recording medium according to claim 17, wherein
the trained model includes a trained model that has learned the characteristic information and the data importance level, and
the process comprises:
determining the encryption scheme according to the data importance level acquired by inputting the characteristic information to the trained model.

19. The non-transitory recording medium according to claim 17, wherein the process comprises:
further provisionally determining a provisional encryption scheme, provisional encryption strength, or a provisional importance level of the data based on the characteristic information and information set in advance according to the characteristic information; and
determining the encryption scheme for encrypting the data by inputting the characteristic information to the trained model in a case where the provisionally determined provisional encryption scheme, provisional encryption strength, or provisional importance level satisfies a predetermined condition.

20. The non-transitory recording medium according to claim 17, wherein the process comprises:
preferentially encrypting, among pieces of the data to be subject to processing for transmission during a predetermined period of time, a piece of the data with a higher emergency level.
